(19) United States
(12) Patent Application Publication
(10) Pub. No.: US 2018/0339263 A1
(43) Pub. Date: Nov. 29, 2018

(54) Apparatus and System for Swing Adsorption Processes

(71) Applicants: Ralph C. Dehaas, Easton, PA (US); Jean W. Beeckman, Columbia, MD (US); Ivy Dawn Johnson, Lawrenceville, NJ (US); Dana L. Mazzaro, Budd Lake, NJ (US); Tilman W. Beutel, Neshanic Station, NJ (US); Bhupender S. Minhas, Bridgewater, NJ (US); Keith R. Hajkowski, Somerset, NJ (US)

(72) Inventors: Ralph C. Dehaas, Easton, PA (US); Jean W. Beeckman, Columbia, MD (US); Ivy Dawn Johnson, Lawrenceville, NJ (US); Dana L. Mazzaro, Budd Lake, NJ (US); Tilman W. Beutel, Neshanic Station, NJ (US); Bhupender S. Minhas, Bridgewater, NJ (US); Keith R. Hajkowski, Somerset, NJ (US)

(21) Appl. No.: 15/982,265

(22) Filed: May 17, 2018

Related U.S. Application Data
(60) Provisional application No. 62/511,612, filed on May 26, 2017.

(51) Int. Cl. B01D 53/047; B01D 53/04; B01D 53/14

(52) U.S. Cl. CPC B01D 53/0473; B01D 53/0462; B01D 53/1475; B01D 2256/24; B01D 2253/108; B01D 2259/40007; B01D 2259/4148; B01D 2259/45; B01D 2257/504

(57) ABSTRACT

Provided are apparatus and systems for performing a swing adsorption process. This swing adsorption process may involve using a selectivation agent to selectivate the adsorbent material. The selectivation agent may be utilized with the swing adsorption process as an in-situ process. The adsorbent material may be utilized for swing adsorption processes to remove one or more contaminants from a feed stream.

### CROSS-REFERENCE TO RELATED APPLICATION

This application claims the benefit of U.S. Provisional Patent Application 62/511,612 filed May 26, 2017 entitled APPARATUS AND SYSTEM FOR SWING ADSORPTION PROCESSES, the entirety of which is incorporated by reference herein.

### FIELD

The present techniques relate to a method and system associated with swing adsorption processes. In particular, the method and system involve an enhanced process for activation of the adsorbent material for hydrocarbon recovery processes, such as a swing adsorption process.

### BACKGROUND

Gas separation is useful in many industries and can typically be accomplished by flowing a mixture of gases over an adsorbent material that preferentially adsorbs one or more gas components, while not adsorbing one or more other gas components. The non-adsorbed components are recovered as a separate product.

One particular type of gas separation technology is swing adsorption, such as temperature swing adsorption (TSA), pressure swing adsorption (PSA), partial pressure swing adsorption (PPSA), rapid cycle temperature swing adsorption (RCTSA), rapid cycle pressure swing adsorption (RCPSA), rapid cycle partial pressure swing adsorption (RCPPSA), and not limited to but also combinations of the fore mentioned processes, such as pressure and temperature swing adsorption. As an example, PSA processes rely on the phenomenon of gases being more readily adsorbed within the pore structure or free volume of an adsorbent material when the gas is under pressure. That is, the higher the gas pressure, the greater the amount of readily-adsorbed gas adsorbed. When the pressure is reduced, the adsorbed component is released, or desorbed from the adsorbent material.

The swing adsorption processes (e.g., PSA and/or TSA) may be used to separate gases of a gas mixture because different gases tend to fill the micropore of the adsorbent material to different extents. For example, if a gas mixture, such as natural gas, is passed under pressure through a vessel containing an adsorbent material that is more selective towards carbon dioxide than it is for methane, at least a portion of the carbon dioxide is selectively adsorbed by the adsorbent material, and the gas exiting the vessel is enriched in methane. When the adsorbent material reaches the end of its capacity to adsorb carbon dioxide, it is regenerated by reducing the pressure, thereby releasing the adsorbed carbon dioxide. Then, the adsorbent material is typically purged and repressurized prior to starting another adsorption cycle.

Swing adsorption processes typically involve adsorption bed units, which include an adsorbent bed disposed within a housing and configured to maintain fluid steams at various pressures for different steps in a cycle within the adsorption bed unit. These adsorption bed units utilize different packing material in the bed structures. For example, the adsorption bed units utilize checker brick, pebble beds or other available packing. Some adsorption bed units may utilize engineered packing within the bed structure. For example, the engineered packing may include a material provided in a specific configuration, such as a honeycomb, ceramic forms or the like.

Further, various adsorbent bed units may be coupled together with conduits and valves to manage the flow of fluids through the cycle. Orchestrating these adsorbent bed units involves coordinating the steps in the cycle for each of the adsorbent bed units with other adsorbent bed units in the system. A complete cycle can vary from seconds to minutes as it transfers various gaseous streams through one or more of the adsorbent bed units.

As may be appreciated, selectivation of adsorbent materials is required to make the process economically viable. The selectivation approaches are typically performed ex-situ. For example, U.S. Patent Application Publication No. 2015/0182947. This publication describes synthesizing ZSM-58 crystals with a reduced level of crystal defects as reflected by lower diffusivities for gaseous adsorbents. The reference describes steaming the crystals prior to incorporation into an adsorbent bed along with other material processing steps, which not able to be performed in-situ. As a result, the material processing steps involve specialized equipment that is not conventionally utilized in the field. Indeed, the steaming process may damage equipment, such as rendering the adsorbent bed unstable because of the steaming conditions involved to selectivate the adsorbent material (e.g., the temperatures and pressures).

As another example, the selectivation of the adsorbent material may involve boron-selectivation, as described in U.S. Patent Application Publication No. 2016/0167013. This publication describes a composition that is a molecular sieve having pores defined by channels formed by one or more 8-membered rings of tetrahedrally coordinated atoms and an amorphous deposit of a boron compound on the molecular sieve. This process involves specialty equipment and material processing steps that may compromise a bed structure. Accordingly, the method has to be performed ex-situ to lessen any damage to the process.

Yet another example, the selectivation of the adsorbent material may involve growing a second zeolite on the surface to impact diffusion, as described in U.S. Patent Application Publication No. 2016/0175759. This publication describes preparing a zeolite core and/or silica zeolite shell composite. The described method may include adding a zeolite seed crystal into a gel solution having a silicon-source compound, a structure directing agent and a fluorine anion-source compound. Then, the gel solution is crystallized to grow a silica zeolite shell containing a crystal structure, which is coherent with that of the zeolite seed crystal. Accordingly, the process involves specialized process equipment and material processing steps, which limits the selectivation to ex-situ methods.

Moreover, U.S. Pat. No. 9,095,809 describes a selectivation process using large hydrocarbons at elevated temperatures and pressures for selectivation the DDR crystal. This reference describes the use of barrier compounds to alter the relative ability of potential adsorbates to enter into and/or move within the pores of the adsorbent. Accordingly, the conditions to selectivate the adsorbent material crystals are described as being quite severe (e.g., high pressures and high temperatures) and requiring large selectivation molecules (e.g., octylamine). The nature of the severe conditions precludes in-situ selectivation and forces selectivation via an external treatment.

Accordingly, there remains a need in the industry for apparatus, methods, and systems that provided enhancements to the selectivation of the adsorbent material for hydrocarbon recovery processes. Further, a need exists for techniques to provide flexibility in the selectivation and techniques that may speed-up the start-up process for a swing adsorption process.

### SUMMARY OF THE INVENTION

In one embodiment, the present techniques comprise a method for performing a swing adsorption process. The method comprising: a) performing a swing adsorption cycle, wherein the swing adsorption cycle comprises performing an adsorption step that comprises passing a feed stream through an adsorbent bed unit having an adsorbent material to separate one or more contaminants from the feed stream to form a product stream, wherein a selectivation agent is passed through the adsorbent material during the swing adsorption cycle; b) determining whether the adsorbent material is selectivated; c) if the adsorbent material is not selectivated, repeating steps a) to b) for at least one additional swing adsorption cycle; and d) if the adsorbent material is selectivated; performing normal operations with the adsorption material.

In yet another embodiment, a cyclical swing adsorption system is described. The cyclical swing adsorption system comprises: a plurality of manifolds, wherein the plurality of manifolds comprise a feed manifold configured to pass a feed stream to the plurality of adsorbent bed units during an adsorption step, a product manifold configured to pass a product stream from the plurality of adsorbent bed units during the adsorption step, a purge manifold configured to pass a purge stream to the plurality of adsorbent bed units during a regeneration step, a purge product manifold configured to pass a purge product stream from the plurality of adsorbent bed units during the regeneration step, and a selectivation manifold configured to pass a selectivation agent to the plurality of adsorbent bed units; a plurality of adsorbent bed units coupled to the plurality of manifolds, each of the adsorbent bed units comprising: a housing, an adsorbent material disposed within the housing, a plurality of valves, wherein at least one of the plurality of valves is associated with one of the plurality of manifolds and is configured to manage fluid flow along a flow path extending between the respective manifold and the adsorbent material.

### BRIEF DESCRIPTION OF THE FIGURES

The foregoing and other advantages of the present disclosure may become apparent upon reviewing the following detailed description and drawings of non-limiting examples of embodiments.

FIG. 1 is a three-dimensional diagram of the swing adsorption system with six adsorbent bed units and interconnecting piping in accordance with an embodiment of the present techniques.

FIG. 2 is a diagram of a portion of an adsorbent bed unit having associated valve assemblies and manifolds in accordance with an embodiment of the present techniques.

FIG. 3 is an exemplary flow chart for performing a start-up mode of a swing adsorption process in accordance with an embodiment of the present techniques.

FIG. 4 is an exemplary chart associated with percentage of starting CO₂ capacity or CH₄ diffusivity as compared with time.

### DETAILED DESCRIPTION OF THE INVENTION

Unless otherwise explained, all technical and scientific terms used herein have the same meaning as commonly understood by one of ordinary skill in the art to which this disclosure pertains. The singular terms “a,” “an,” and “the” include plural referents unless the context clearly indicates otherwise. Similarly, the word “or” is intended to include “and” unless the context clearly indicates otherwise. The term “includes” means “comprises.” All patents and publications mentioned herein are incorporated by reference in their entirety, unless otherwise indicated. In case of conflict as to the meaning of a term or phrase, the present specification, including explanations of terms, control. Directional terms, such as “upper,” “lower,” “top,” “bottom,” “front,” “back,” “vertical,” and “horizontal,” are used herein to express and clarify the relationship between various elements. It should be understood that such terms do not denote absolute orientation (e.g., a “vertical” component can become horizontal by rotating the device). The materials, methods, and examples recited herein are illustrative only and not intended to be limiting.

As used herein, “stream” refers to fluid (e.g., solids, liquid and/or gas) being conducted through various equipment. The equipment may include conduits, vessels, manifolds, units or other suitable devices.

As used herein, “conduit” refers to a tubular member forming a channel through which a stream may be conveyed. The conduit may include one or more of a pipe, a manifold, a tube or the like.

As used herein, “in-situ” refers to operations or procedures that are performed at the location the normal operations are to be performed. By way of example, an in-situ process may be performed on location or in equipment that the normal operations are performed, which is performed without isolating the equipment and materials from other processes. As another example, in-situ selectivation of an adsorbent material refers to a selectivation process that is performed with the equipment of the process at the location of that the adsorbent material is to be utilized for the process during normal operations, which includes the adsorbent material being disposed within a respective unit during the selectivation process.

As used herein, “ex-situ” refers to operations or procedures that are performed at an external location from the location of normal operations and/or with equipment that is not utilized for normal operations. By way of example, ex-situ selectivation of an adsorbent material refers to a selectivation process being performed at a different location from the normal operations' location and/or the selectivation process being performed with different equipment from the equipment utilized for normal operations.

Swing adsorption processes include adsorption bed units, which include adsorbent beds disposed within a housing and configured to maintain fluids at various pressures for different steps in a cycle within the adsorbent bed unit. The adsorption bed units are configured to utilize different adsorbent material to modify a stream into a product stream and one or more regeneration streams, which may include one or more streams containing contaminants. As a specific example, the swing adsorption process may involve an adsorption step and a regeneration step in the swing adsorption cycle.

To remove the contaminants from the feed stream, the adsorbent material is selectivated. As noted above, selectivation of the adsorbent material is utilized to have the swing adsorption process be economically viable. For example, selectivation of the adsorbent materials, such as ZSM-58 crystals, may involve steaming the adsorbent material, performing boron-selectivation on the adsorbent material, or growing a second zeolite on the surface to impact diffusion. Further, yet other approaches involve using large hydrocarbons at elevated temperatures and pressures for selectivation the adsorbent material. These different approaches are challenging and are limited to selectivation via an external treatments, which may be referred to as ex-situ. Indeed, the selectivation approaches may even preclude in-situ selectivation, which is performing the selectivation within the unit for normal operations.

The present techniques enhance the performance of operations by providing flexibility in the selectivation of the adsorbent material. For example, the present techniques may perform the selectivation ex-situ, in-situ or a combination of ex-situ and in-situ. The ex-situ selectivation may be performed during the adsorbent bed construction prior to implementation, during the shipping of the adsorbent material and/or during preparation of the adsorbent material, by contacting the adsorbent material with a selectivation agent. Also, the in-situ selectivation may be performed in the adsorbent bed unit during start-up operations. As a specific example, the present techniques may involve selectivation that is performed in-situ using selectivation agents that are injected into the streams passing through the adsorbent material. In contrast to other approaches that have to be performed external to the unit, the selectivity of the adsorbent material may be adjusted while the adsorbent material is disposed within the unit. This is useful because it provides a process for adjusting selectivity of the adsorbent material within a unit, which may be performed at start-up or during normal operations when the adsorbent material is not performing at a preferred level. Further, a combination of ex-situ and in-situ selectivation may also be performed to further lessen the selectivation timeframe for the adsorbent material during start-up operations.

As may be appreciated, performing the swing adsorption process may eventually selectivate the adsorbent material as certain contaminants may be present in streams passing through the adsorbent material. However, the present techniques provide a selectivation agent in a selectivation spike to enhance the selectivation of the adsorbent material, which may lessen the period of time involved in the selectivation process as compared with the normal performance of the swing adsorption process. By way of example, the selectivation spike may be provided ex-situ during adsorbent material preparation and/or may be provided in-situ during startup operations or normal operations. For in-situ selectivation, the selectivation spike may be provided at or near the beginning of a feed step, near or at the end of a purge step, near or at the end of a repressurization step and/or as a separate selectivation step. The benefit of performing the selectivation in-situ is that it may be performed at the facility location and does not require a separate manufacturing protocol, such as steaming, for example, to provide the targeted diffusivity (e.g., methane diffusivity). Further, it may also be utilized to enhance the selectivity of adsorbent material that is not performing at a preferred level as a result of a disruption to the normal operation of the process. Accordingly, the present techniques provides flexibility in the implementation of the selectivation of the adsorbent material.

The selectivation may be performed by exposing the adsorbent material in the adsorbent bed unit to selectivation agents to lessen diffusivity of targeted materials. The selectivation agents may include small molecules, such as monoethanolamine (MEA) and/or water (H₂O), for example. The selectivation agents may be compounds that are instrinsic to the feed stream (e.g., found in natural gas processing facilities), while other selectivation agents may be compounds that are extrinsic to the feed stream. By way of example, the selectivation spike may be performed to expose the crystals in the adsorbent material to small molecules other than carbon dioxide (CO₂) and methane (CH₄), which may include hydrocarbons other than methane (e.g., ethane, propane or butane), amines, and/or mercaptanes. These molecules may decrease the diffusivity, which slows the adsorption of CH₄, as measured by Zero Length Chromatography (ZLC), but may maintain the carbon dioxide (CO₂) capacity. Also, the selectivation agents may include organics that may be present in the process and/or related processes.

In certain embodiments, the present techniques may lessen the diffusivity of methane in the adsorbent material, such as ZSM-58 (DDR) crystals, using small organic molecules that may be found as trace impurities in the natural gas feed stream. As the swing adsorption process may be configured to adsorb CO₂ and pass the CH₄ through the adsorbent bed, the modifications to decrease CH₄ diffusivity should not significantly impact the CO₂ capacity of the crystals in the adsorbent material. For example, if the adsorbent material includes ZSM-58 crystals, the ZSM-58 crystals may have a size in the range between 10 microns and 25 microns and a CH₄ diffusivity (DCH₄), in the range between 10×10⁻¹³ and 15×10⁻¹³ squared centimeters per second (cm²/sec). As the swing adsorption process is a highly selective separation of methane from carbon dioxide, the swing adsorption process relies on the relative diffusivities of CH₄ and CO₂, which involves a diffusivity of CH₄ that exceeds the diffusivity range desired for a swing adsorption process. Accordingly, exposing the crystals of the adsorbent material to a hydrocarbon stream, which may include monoethanolamine (MEA) as the selectivation agent, lessens the diffusivity of methane in the crystals, while having only a minimal impact on CO₂ capacity. Because MEA is typically available and compatible with the feed stream, using MEA to dope certain levels of a spike (e.g., trace levels) into the feed stream may be performed inexpensively and may performed by diverting a split stream or other relatively straightforward approaches to obtain and introduce the stream. While the selectivation may lessen the diffusivity of CH₄, the methane has a natural minimum DCH₄. This surprising result, as it shown below, indicates that the adsorbent material does not continue to be selectivated to the point of lessening CO₂ capacity.

To further understand the present techniques, various examples are described below. The examples involve different samples of adsorbent materials being exposed to streams having different compositions. In particular, samples of ZSM-58 adsorbent material were exposed to streams in a dynamic fouling unit (DFU), which includes a first dynamic test unit and a second dynamic test unit. The dynamic test units are configured to test multiple adsorbent samples simultaneously. The samples may be pretreated in the dynamic test units under pressures in the range between vacuum pressure and 1000 pounds per square inch gauge (psig) and temperatures in the range between ambient temperature (e.g., average temperature of surrounding environment, which may be in the range between 60° F. and 80° F.) and 800° F. The dynamic test units may be used to expose samples of adsorbent materials to a stream of a single component or a multiple-component gas. In addition, liquids, such as water or amines, may be added in the feed stream from partial saturation to 100% saturation concentrations. The dynamic test units may be configured to operate under static gas pressures as well as under pressure swing modes, which may cycle gas pressures in the range between 50 psig and 900 psig, for example. Also, the operations may involve isothermal conditions or temperatures may be cycled to temperatures in the range between ambient temperatures (e.g., 15.6° C. or 26.7° C.) and 100° C.

By way of example, the feed stream may include a first feed stream, which may be referred to as Base Gas 1, and a second feed stream, which may be referred to as Base Gas 2. The selectivation agents may include water and/or monoethanolamine (MEA), which are spiked into the respective first and second feed streams. The compositions of the respective feed streams is shown below in Table 1.

TABLE 1

| | | |
|---|---|---|
| Component | Base Gas 1 | Base Gas 2 |

| | | | | |
|---|---|---|---|---|
| CH₄ | 75 | vol. % | 91.7 | vol. % |
| CO₂ | 14 | vol. % | 50 | ppm |
| H₂S | 10 | vol. % | 0 | vol. % |
| Ethane (C₂H₆) | 1.5 | vol. % | 6.1 | vol. % |
| Propane | 0.0 | vol. % | 1.9 | vol. % |
| Butane | 0.0 | vol. % | 0.3 | vol. % |

The Base Gas 1 and Base Gas 2 streams are utilized to represent exemplary natural gas streams. Methane is the predominant component at 75 volume percent (vol. %) in the Base Gas 1 stream and 91.7 vol. % in the Base Gas 2 stream. Carbon dioxide is 14 vol. % in the Base Gas 1 and 50 parts per million in Base Gas 2, while the heavy hydrocarbons (e.g., ethane, propane and butane) are 1.5 vol. % in Base Gas 1 and 8.3 vol. % in Base Gas 2. Accordingly, the Base Gas 1 represents a stream having higher volumes of carbon dioxide, while Base Gas 2 represents a stream that has a higher volume of heavier hydrocarbons.

In addition to MEA and water, other trace components may be utilized as selectivation agents. For example, as shown in Table 2 below, certain selectivation agents may be intrinsic compounds to the feed stream (e.g., found in natural gas processing facilities), while other selectivation agents may be extrinsic compounds to the feed stream. Accordingly, the selectivation agents may include components that are present within the processing facility or components removed from the natural gas stream upstream of the swing adsorption process.

TABLE 2

| Intrinsic - Natural to Gas | Extrinsic - Added to Gas Stream | |
|---|---|---|
| Stream | i.e. Oil Field Chemicals | Type of Oil Field Chemical |
| H2S | TEG | Dehydration |
| CO2 | MEG | Hydrate Inhibitor |
| He | Methanol | Hydrate Inhibitor |
| N2 | Kinetic Hydrate Inhibitors | Hydrate Inhibitor |
| Methane | Toulene | Oil Field Chemical Solvent |
| Ethane | Benzene | Oil Field Chemical Solvent |
| Propane | Xylene | Oil Field Chemical Solvent |
| i-Butane | EGMBE | Oil Field Chemical Solvent |
| n-Butane | Cyclohexyl Amine | Corrosion Inhibitor Component |
| i-Pentane | MEA | Corrosion Inhibitor Component |
| n-Pentane | DEA | Corrosion Inhibitor Component |
| n-Hexane | MDEA | Corrosion Inhibitor Component |
| Cyclopentane, Methyl- | Triamines | Corrosion Inhibitor Component |
| Cyclopentane | Triazines | Corrosion Inhibitor Component |
| Benzene | Quantetary Amines | Corrosion Inhibitor Component |
| Toluene | Phosphate Esters | Scale Inhibitors |
| m-Xylene | Organo Phosphates | Scale Inhibitors |
| Cyclohexane, Methyl- | Cetyl Amine | Scale Inhibitors |
| C7 | Folic Acid | Scale Inhibitors |
| C8 | Glutaraldehyde | Biocides |
| C9 | THPS | Biocides |
| C10 | HCL | Well Workovers |
| COS | Formic Acid | Well Workovers |
| Methyl Mercaptan | Acetic Acid | Well Workovers |
| Ethyl Mercaptan | Polyolefins | Drag Reducing Agent |
| 2-Propanethiol | Vinyl acetate (EVA) | Wax Inhibitor |
| 1-Propanethiol | Alkylarylsulfonate Amine | Wax Inhibitor |
| tert-Butyl Mercaptan | Sodium Bisulfite | O2 Scavenger |
| n-Butyl Mercaptan | Ammonuim Bisulfite | O2 Scavenger |
| 1-Pentanethiol | DMDS | Sulfur Solvent |
| 1-Hexanethiol | Branched Sulfonic Acids | Emulsion Breakers |
| 1-Octanethiol | Quanternary Ammonuim Hydroxide | Mercaptan Scavenger |
| Thiophene | Imines | Mercaptan Scavenger |
| 2-Methylthiophene | Silicones | Antifoam Agents |
| Dimethyl Disulfide | Fatty Acid Esters | Antifoam Agents |
| Dibenzothiophene (DBT) | Alykl Benzene Sulfonic Acid | Asphaltene Control Agents |
| CS2 | O2 | Leakage into System |
| S8 | | |
| FeS | | |
| H2O | | |
| Asphaltenes | | |

In Table 2, the selectivation agents in column 1 may be naturally occurring chemicals present in the streams being processed from a hydrocarbon field. The intrinsic selectivation agents may include chemicals, compounds or elements that are present within the subsurface formation and/or present within the conduits passing the fluid to the process. The selectivation agents in column 2 may be chemicals that are not naturally occurring and are added to the stream for the selectivation, which may be later removed downstream. The type of oil field chemical associated with the respective selectivation agent in column 2 is shown in column 3. Each of these selectivation agents may be used to improve diffusivity.

To review certain selectivation agents, various experiments were performed that involved ZSM-58 crystals were exposed to selectivation agents for given periods of time. After exposure, the samples were analyzed via ZLC for CH₄ diffusion (DCH₄) and a standard CO₂ isotherm for CO₂ capacity.

ZLC may be used to measure diffusivities of gaseous components. The present techniques utilizes ZLC to track methane diffusivities, as synthesis and/or treatment parameters vary, to provide validation of higher-desirability candidates for certain processes. Specifically, ZLC determines diffusion coefficients from measurements of rates at which adsorbed molecules are purged from adsorption samples after rapidly switching from adsorption to desorption conditions. Analysis of zero length chromatography data methods is described, e.g., by J. Karger, D. M. Ruthven and D. N. Theodorou in “Diffusion in Nanoporous Materials”, vol. 1, pp. 483-501, Wiley-VCH Verlag & Co. KGaA, Germany (2012).

The ZLC techniques may be used to determine the diffusivity of methane in the adsorbent material, such as zeolite crystals. The ZLC technique was used to measure the rate of desorption of a gaseous sorbate from a solid sorbent in the presence of a concentration gradient. The ZLC process includes two steps that are performed at the same temperature and total pressure: i) an adsorption step, during which a gaseous sorbent is adsorbed into the micropores of the adsorbent material, which should be performed for a duration to achieve equilibration between the gaseous and the adsorbed sorbate phase; and ii) a desorption or purge step, during which the sorbate is desorbed from the adsorbent material in an inert gas flow. The sorbate concentration in the effluent gas may be monitored by a gas analyzer, and the rate of diffusion of the sorbate may be calculated from the concentration profile of the sorbate as a function of time during the purge step. The flow rate of the purge gas should be high enough to provide rapid removal of sorbate gas from the surface of the sorbent as well as from the void volume between the sorbent crystals. As a result of the efficient sample purge, the diffusion of sorbate throughout the sorbent may occur in the presence of a concentration gradient, resulting in the measurement of transport diffusivities. Consequently, the diffusivities determined from the sorbate concentration profile measured in this experiment may be determined by the mass transfer rate of sorbate inside the zeolitic micropores. The ZLC measurements may use relatively small sample amounts, so as to minimize heat and external mass transfer effects.

The ZLC experiments were conducted under standard conditions in the present techniques. Examples of ZLC techniques are described in U.S. Patent Application Publication Nos. 2015/0182947 and 2016/0167013, and U.S. Pat. No. 9,095,809, which are hereby incorporated by reference. One aspect monitored was the degassing temperatures used prior to the analysis. Conventional degassing prior to the ZLC measurement is performed at 200° C. However, given the volatile nature of the selectivation agents, a second test was instituted using a lower degassing temperature of 60° C. The degassing temperature is a useful parameter in evaluating the DCH₄ of the selectivated adsorbent material.

For each of the examples, which are listed in Table 3, the adsorbent material was disposed in the DFU and exposed to a selectivation agent for the given period of time, which are described in Table 3 below. As shown in Table 3, the samples in the different examples were exposed to selectivation agents for various periods of time and resulted in various percentages of retention of CO₂ capacity and percentage decrease in D(CH₄).

TABLE 3

| | | | Percentage (%) | Percentage |
|---|---|---|---|---|
| | | Exposure | retention | (%) |
| Exam- | | time, | of CO₂ | decrease in |
| ple No. | Gas stream | weeks | capacity | D(CH₄) |
| A1 | ZSM-58 starting | 0 | 100% | 100% |
| | crystal | | | |
| A2 | Base Gas 1 and | 3 | 95% | 43% |
| | water | | | |
| A3 | Base Gas 1 and | 2 | 106% | 62% |
| | MEA | | | |
| A4 | ZSM-58 starting | 0 | 100% | 100% |
| | crystal | | | |
| A5 | Base Gas 1 | 1 | 106% | 63% |
| A6 | ZSM-58 starting | 0 | 100% | 100% |
| | crystal | | | |
| A7 | Base Gas 1 | 1 | 99% | 69% |
| A8 | Base Gas 1, MEA, | 1 | 96% | 67% |
| | and H₂O | | | |
| A9 | parent H-[Al]DDR | 0 | Not | 100% |
| | | | available | |
| A10 | Base Gas 1 and | 3 | Not | 58% |
| | H₂O | | available | |
| A11 | Base Gas 1 and | 2 | Not | 63% |
| | MEA | | available | |

As shown in Table 3, the various examples include percentages of retention of CO₂ capacity and percentage decrease in D(CH₄), which is based on the exposure time for the respective examples. The percentages include an error percentage that is plus or minus 7% of the experimental results. The examples A1, A4 and A6 are of the starting material without the streams. In examples A2, A3, A5, A7 and A8 the different combination of base gases alone or with a specific selectivation agent. Accordingly, the examples provide that the selectivation agents may be used to enhance the selectivation of the adsorbent material. Further, example A2 demonstrates the impact of degassing temperature on the DCH₄ measured via ZLC. As the degassing temperature increases, more adsorbed species are removed from the zeolite pores creating faster methane diffusion, which negates some of the selectivation.

Further, in the H-[A1]DDR term of example 9, the descriptor “H” refers to proton exchanged, “[A1]” refers to aluminum in the silica framework, “DDR” refers to the structure of the zeolite framework. In example A9, the zeolite framework is primarily Silica and contains A1. The examples A9, A10 and A11 demonstrate that having aluminum in the adsorbent crystal framework up to SiO₂/Al₂O₃ molar ratios up to 150:1 does not impact the reduction in DCH₄ after selectivation. The examples A10 and A11 demonstrate the ability of the base gas to selectivate the adsorbent material, which enhances the DCH₄. In the examples, the MEA negated some of the selectivating impact of the base gas.

As shown in Table 4 below, examples B1 to B14 are provided to demonstrate that extended exposure to a selectivation agent does not have a deleterious effect on either the CO₂ capacity or the DCH₄, which does not poison the adsorbent material. These results support the supposition that small hydrocarbon components of the base gas mixtures provide a self-regulating selectivating coating to decrease the rate of methane uptake, but does not continuously add to the adsorbent blocking all access. There is also no evidence of loss of capacity of the adsorbent, as measured by CO₂ uptake.

Table 4 is an example demonstrating that the selectivation process described herein does not have a significant impact on CO₂ capacity. This aspect has to be considered because improving the selectivity to CO₂ as described above does not provide the desired value if the adsorbent substantially decreases CO₂ capacity.

TABLE 4

| | | Exposure | Percentage | Percentage |
|---|---|---|---|---|
| Exam- | | time in | (%) CO₂ | (%) |
| ple No. | Gas stream | weeks | capacity | D(CH₄) |
| B1 | Steamed ZSM-58 starting | 0 | 100% | 100% |
| | crystal | | | |
| B2 | Base gas, MEA and water | 2 | 95% | 70% |
| B3 | Base gas, MEA and water | 3 | 105% | 71% |
| B4 | Base gas, MEA and water | 6 | 100% | 67% |
| B5 | Base gas, MEA and water | 8 | 85% | 70% |
| B6 | Base gas, MEA and water | 10 | 102% | 68% |
| B7 | Base gas, MEA and water | 12 | 97% | 67% |
| B8 | Base gas, MEA and water | 14 | 98% | 70% |
| B9 | Base gas, MEA and water | 18 | 97% | 66% |
| B10 | Base gas, MEA and water | 20 | 97% | 63% |
| B11 | Base gas, MEA and water | 22 | 101% | 65% |
| B12 | Base gas, MEA and water | 24 | 97% | 63% |
| B13 | Base gas, MEA and water | 26 | 100% | 68% |
| B14 | Base gas, MEA and water | 28 | 101% | 65% |

As shown in Table 4, the various examples include percentages of retention of CO₂ capacity and percentage decrease in D(CH₄), which is based on the exposure time for the respective examples. The percentages include an error percentage that is plus or minus 7% of the experimental results. The example B1 is of the starting material without the stream. In examples B2 to B14, the base gas along with MEA and water is provided for varying periods of time, which does not substantially change the percentage of retention of CO₂ capacity or percentage decrease in D(CH₄). Accordingly, the period of exposure does not significantly change the percentage of retention of CO₂ capacity or percentage decrease in D(CH₄).

By way of example, the present techniques may comprise a method for performing a swing adsorption process. The method may comprise: a) performing a swing adsorption cycle, wherein the swing adsorption cycle comprises performing an adsorption step that comprises passing a feed stream through an adsorbent bed unit having an adsorbent material to separate one or more contaminants from the feed stream to form a product stream, wherein a selectivation agent is passed through the adsorbent material during the swing adsorption cycle; b) determining whether the adsorbent material is selectivated; c) if the adsorbent material is not selectivated, repeating steps a) to b) for at least one additional swing adsorption cycle; and d) if the adsorbent material is selectivated; performing normal operations with the adsorption material.

Further, in certain configurations, the method may include various enhancements. For instance, the method may include: wherein performing the adsorption step comprises mixing the selectivation agent with the feed stream and passing the selectivation agent and the feed stream through the adsorbent bed unit; wherein the selectivation agent is mixed with the feed stream during the first half of the adsorption step or during the first quarter of the adsorption step; wherein performing the swing adsorption cycle comprises performing a purge step that involves passing a purge stream through an adsorbent bed unit to remove one or more contaminants from an adsorbent bed within a housing of the adsorbent bed unit to form a purge product stream; wherein performing the purge step comprises mixing the selectivation agent with the purge stream and passing the selectivation agent and the purge stream through the adsorbent bed unit; wherein the selectivation agent is mixed with the purge stream during a later half of the purge step or during a last quarter of the purge step; wherein performing the swing adsorption cycle comprises: determining whether the product stream is within a specification for a contaminant, if the product stream is within the specification, passing the product stream to a downstream process, and if the product stream is not within the specification, repeating the swing adsorption cycle for at least one additional cycle; wherein the selectivation agent includes intrinsic compounds to the feed stream or extrinsic compounds to the feed stream or comprises water; wherein the cycle duration is for a period greater than 1 second and less than 600 seconds; wherein the gaseous feed stream is a hydrocarbon containing stream having greater than one volume percent hydrocarbons based on the total volume of the feed stream; wherein the gaseous feed stream comprises hydrocarbons and CO₂, wherein the CO₂ content is in the range of two hundred parts per million volume and less than or equal to about 2% volume of the gaseous feed stream; wherein the adsorbent bed unit is configured to lower the carbon dioxide (CO₂) level to less than 50 parts per million; passing the product stream from the adsorbent bed unit to a liquefied natural gas process unit and separating a flash fuel stream (i.e., a low boiling point stream comprising methane which is stream is substantially a vapor at atmospheric conditions) from the LNG process unit to be utilized as at least a portion of the purge stream; passing the product stream from the adsorbent bed unit to a cryogenic natural gas liquefaction (CNGL) process unit and separating an overhead stream from the CNGL process unit to be utilized as at least a portion of the purge stream; and/or selectivating the adsorbent material prior to disposing the adsorbent material into the adsorbent bed unit.

In yet another configuration, the present techniques may include a cyclical swing adsorption system. The cyclical swing adsorption system may comprise: a plurality of manifolds, wherein the plurality of manifolds comprise a feed manifold configured to pass a feed stream to the plurality of adsorbent bed units during an adsorption step, a product manifold configured to pass a product stream from the plurality of adsorbent bed units during the adsorption step, a purge manifold configured to pass a purge stream to the plurality of adsorbent bed units during a regeneration step, a purge product manifold configured to pass a purge product stream from the plurality of adsorbent bed units during the regeneration step, and a selectivation manifold configured to pass a selectivation agent to the plurality of adsorbent bed units; a plurality of adsorbent bed units coupled to the plurality of manifolds, each of the adsorbent bed units comprising: a housing, an adsorbent material disposed within the housing, a plurality of valves, wherein at least one of the plurality of valves is associated with one of the plurality of manifolds and is configured to manage fluid flow along a flow path extending between the respective manifold and the adsorbent material.

In addition, certain embodiments of the system may include various enhancements. For instance, the cyclical swing adsorption system may include wherein the plurality of valves comprise one or more poppet valves; wherein plurality of manifolds, the plurality of adsorbent bed units are configured to operate at pressures between 0.1 bar absolute (bara) and 100 bara; a selectivation agent valve in fluid communication with the feed manifold and configured to provide a flow passage for the selectivation agent from an external storage vessel to the feed manifold in a start-up mode position and configured to block the flow passage of the selectivation agent from the external storage vessel to the feed manifold in a normal operation mode position; a conditioning unit disposed downstream of the product manifold and upstream of the external storage vessel, wherein the conditioning unit is configured to remove selectivation agents from the product stream; a selectivation agent valve in fluid communication with the purge manifold and configured to provide a flow passage for the selectivation agent from an external storage vessel to the purge manifold in a start-up mode position and configured to block the flow passage of the selectivation agent from the external storage vessel to the purge manifold in a normal operation mode position; a conditioning unit disposed downstream of the purge product manifold and upstream of the external storage vessel, wherein the conditioning unit is configured to remove selectivation agents from the purge product stream; and/or a liquefied natural gas process unit in fluid communication with the adsorbent bed unit and configured to receive the product stream and separate the product stream into a final product stream and a flash fuel stream, wherein the flash fuel stream is passed to the purge manifold.

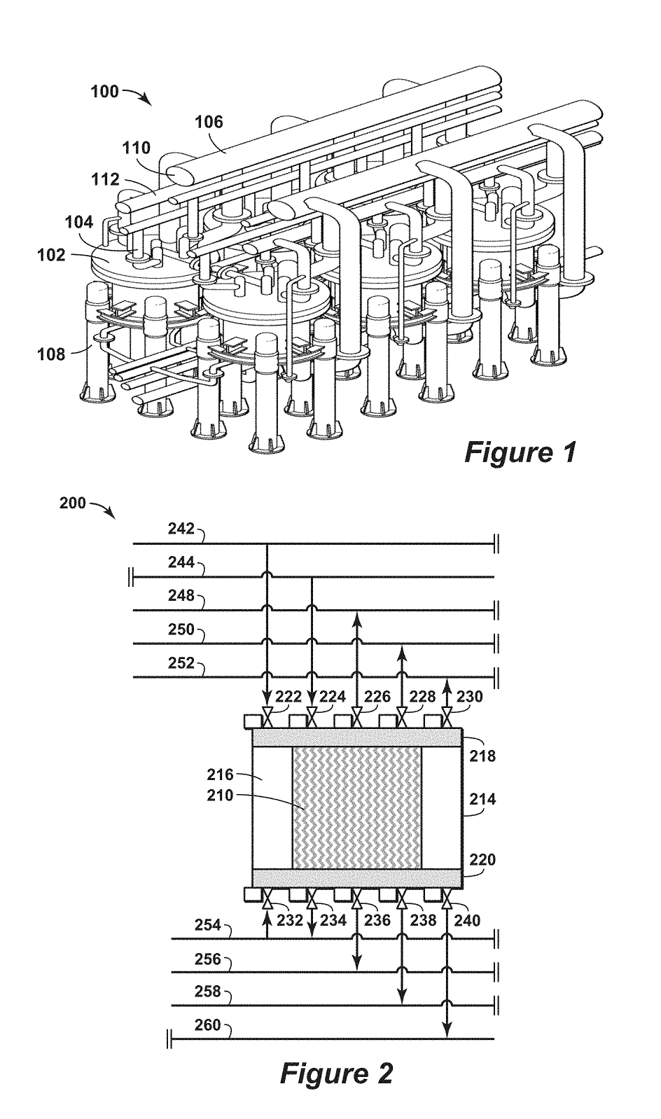

Beneficially, the present techniques provide flexibility to perform the selectivation in-situ, ex-situ and/or a combination thereof. Also, the selectivation agents that already present in the natural gas stream and do not involve pressures and/or temperatures that are higher compared to the normal operation mode. The present techniques may be further understood with reference to the FIGS. 1 to 4 below.

FIG. 1 is a three-dimensional diagram of the swing adsorption system 100 having six adsorbent bed units and interconnecting piping. While this configuration is a specific example, the present techniques broadly relate to adsorbent bed units that can be deployed in a symmetrical orientation, or non-symmetrical orientation and/or combination of a plurality of hardware skids. Further, this specific configuration is for exemplary purposes as other configurations may include different numbers of adsorbent bed units.

In this system, the adsorbent bed units, such as adsorbent bed unit 102, may be configured for a cyclical swing adsorption process for removing contaminants from feed streams (e.g., fluids, gaseous or liquids). For clarity, the term “gaseous feed stream” as used herein means a feed stream which components are substantially in the gaseous phase at the operating conditions, but may contain some amount of liquids and/or solids. In preferred embodiments, herein the “gaseous feed stream” contains at least 80, at least 85, at least 90, at least 95, at least 98, or substantially 100 vol % of the gaseous feed stream in the vapor phase at the operating conditions. The term “feed stream” as used herein may be a gaseous feed stream or be comprised of a gaseous feed stream unless otherwise noted. For example, the adsorbent bed unit 102 may include various conduits (e.g., conduit 104) for managing the flow of fluids through, to or from the adsorbent bed within the adsorbent bed unit 102. These conduits from the adsorbent bed units 102 may be coupled to a manifold (e.g., manifold 106, which is shown with a typical end cap 110) to distribute the flow to, from or between components. The adsorbent bed within an adsorbent bed unit may separate one or more contaminants from the feed stream to form a product stream. As may be appreciated, the adsorbent bed units may include other conduits to control other fluid steams as part of the process, such as selectivation spike streams, purge streams, depressurizations streams, and the like. In particular, the adsorbent bed units may include start-up mode equipment, such as one or more heating units (not shown), one or more external selectivation source manifolds, which may be one of the manifolds 106) and one or more other gas sources, which may be used as part of the start-up mode for the adsorbent beds. Further, the adsorbent bed unit may also include one or more equalization vessels, such as equalization vessel 108, which are dedicated to the adsorbent bed unit and may be dedicated to one or more step in the swing adsorption process.

As an example, the equalization vessels may be used to store selectivation agents or other compounds. In such a configuration, the selectivation system may include the equalization vessels 108, separation units, pumps, compressors, conduits and/or valves. The selectivation agent may be stored in the equalization vessels and include conduits and valves that are configured to (i) pass the selectivation agent to the adsorbent bed (e.g., via one or more of the manifolds or via a separate manifold) when the adsorbent material in the adsorbent bed is being selectivated (e.g., during start-up operations or during normal operations, when the adsorbent material is being selectivated); and (ii) to hinder or block the flow of selectivation agent to the adsorbent bed when the adsorbent material in the adsorbent bed is not being selectivated or when the process does involve the use of the selectivation agent. In addition, the selectivation system may include a separation unit downstream of the adsorbent bed and configured to separate a portion of the selectivation agents from the streams conducted away from the adsorbent bed. Further, the selectivation system may include pumps and/or compressors configured to promote flow of the selectivation agents by compressing the selectivation agents to an appropriate pressure, which may depend on the operating conditions within the star-up operations or normal operations, and by passing the selectivation agent through the conduits and/or manifolds.

As noted further below in FIG. 2, the adsorbent bed unit 102 may include a housing, which may include a head portion and other body portions, that forms a substantially gas impermeable partition, an adsorbent bed disposed within the housing and a plurality of valves (e.g., poppet valves) providing fluid flow passages through openings in the housing between the interior region of the housing and locations external to the interior region of the housing. Each of the poppet valves may include a disk element that is seatable within the head or a disk element that is seatable within a separate valve seat inserted within the head (not shown). The configuration of the poppet valves may be any variety of valve patterns or configuration of types of poppet valves. As an example, the adsorbent bed unit may include one or more poppet valves, each in flow communication with a different conduit associated with different streams. The poppet valves may provide fluid communication between the adsorbent bed and one of the respective conduits, manifolds or headers. The term “in direct flow communication” or “in direct fluid communication” means in direct flow communication without intervening valves or other closure means for obstructing flow. As may be appreciated, other variations may also be envisioned within the scope of the present techniques.

The adsorbent bed comprises a solid adsorbent material capable of adsorbing one or more components from the feed stream. Such solid adsorbent materials are selected to be durable against the physical and chemical conditions within the adsorbent bed unit 102 and can include metallic, ceramic, or other materials, depending on the adsorption process. Further examples of adsorbent materials are noted further below.

FIG. 2 is a diagram of a portion of an adsorbent bed unit 200 having valve assemblies and manifolds in accordance with an embodiment of the present techniques. The portion of the adsorbent bed unit 200, which may be a portion of the adsorbent bed unit 102 of FIG. 1, includes a housing or body, which may include a cylindrical wall 214 and cylindrical insulation layer 216 along with an upper head 218 and a lower head 220. An adsorbent bed 210 is disposed between an upper head 218 and a lower head 220 and the insulation layer 216, resulting in an upper open zone, and lower open zone, which open zones are comprised substantially of open flow path volume. Such open flow path volume in adsorbent bed unit contains gas that has to be managed for the various steps. The housing may be configured to maintain a pressure from 0 bara (bar absolute) to 150 bara within the interior region.

The upper head 218 and lower head 220 contain openings in which valve structures can be inserted, such as valve assemblies 222 to 240, respectively (e.g., poppet valves). The upper or lower open flow path volume between the respective head 218 or 220 and adsorbent bed 210 can also contain distribution lines (not shown) which directly introduce fluids into the adsorbent bed 210. The upper head 218 contains various openings (not show) to provide flow passages through the inlet manifolds 242 and 244 and the outlet manifolds 248, 250 and 252, while the lower head 220 contains various openings (not shown) to provide flow passages through the inlet manifold 254 and the outlet manifolds 256, 258 and 260. Disposed in fluid communication with the respective manifolds 242 to 260 are the valve assemblies 222 to 240. If the valve assemblies 222 to 240 are poppet valves, each may include a disk element connected to a stem element which can be positioned within a bushing or valve guide. The stem element may be connected to an actuating means, such as actuating means (not shown), which is configured to have the respective valve impart linear motion to the respective stem. As may be appreciated, the actuating means may be operated independently for different steps in the process to activate a single valve or a single actuating means may be utilized to control two or more valves. Further, while the openings may be substantially similar in size, the openings and inlet valves for inlet manifolds may have a smaller diameter than those for outlet manifolds, given that the gas volumes passing through the inlets may tend to be lower than product volumes passing through the outlets.

In swing adsorption processes, the cycle involves two or more steps that each has a certain time interval, which are summed together to be the cycle time or cycle duration. These steps include regeneration of the adsorbent bed following the adsorption step using a variety of methods including pressure swing, vacuum swing, temperature swing, purging (via any suitable type of purge fluid for the process), and combinations thereof. As an example, a PSA cycle may include the steps of adsorption, depressurization, purging, and re-pressurization. When performing the separation at high pressure, depressurization and re-pressurization (which may be referred to as equalization) may be performed in multiple steps to reduce the pressure change for each step and enhance efficiency. In some swing adsorption processes, such as rapid cycle swing adsorption processes, a substantial portion of the total cycle time is involved in the regeneration of the adsorbent bed. Accordingly, any reductions in the amount of time for regeneration results in a reduction of the total cycle time. This reduction may also reduce the overall size of the swing adsorption system.

Further, in start-up mode for the swing adsorption process, one or more of the manifolds and associated valves may be utilized as a dedicated flow path for one or more start-up streams, which may include a selectivation stream that includes selectivation agents alone or with other fluids. For example, during the adsorption or feed step, the manifold 242 and valve assembly 222 may be utilized to pass the feed gas stream to the adsorbent bed 210, while the valve assembly 236 and manifold 256 may be used to conduct away the product stream from the adsorbent bed 210. During this adsorption step, the selectivation agents may be mixed with the feed stream as a selectivation spike. During the regeneration or purge step, the manifold 244 and valve assembly 224 may be utilized to pass the purge stream or recycle stream to the adsorbent bed 210, while the valve assembly 236 and manifold 256 may be used to conduct away the purge product stream from the adsorbent bed 210. During the regeneration step, the selectivation agent may be mixed with the external gas stream as the selectivation spike, which may be at or near the end of the regeneration step. As yet another example, during the adsorption or regeneration step, the manifold 254 and valve assembly 232 may be utilized to pass the selectivation stream to the adsorbent bed 210, while the valve assembly 230 and manifold 252 may be used to conduct away the product selectivation stream from the adsorbent bed 210. In such configuration, the manifold 254 and valve assembly 232 may be utilized for start-up mode processes, but used for blow-down steps during normal operation mode. As may be appreciated, the purge stream and the selectivation streams may be configured to flow counter current to the feed stream. Alternatively, the startup operation mode for the swing adsorption process may involve sharing one or more of the manifolds and associated valves during the normal operation mode and during start-up mode.

During normal operation mode, a gaseous feed stream may be subject to various processes to form a CNGL stream or a LNG stream. For example, the process may include a mercury removal unit to remove mercury from an input stream; a filter to remove both particular and liquid droplets; a swing adsorption unit to remove one or more contaminants, such as H₂O, CO₂ and sulfur containing species; a LNG process unit or CNGL process unit to process the resulting stream into a final product that may be used for sales, shipment or storage. In addition, the configuration may include one or more of a heating loop, a compressor, a heating unit and/or a storage vessel.

As noted above, the present techniques include various procedures that may be utilized to selectivate the adsorbent material for an enhanced start-up mode process for the swing adsorption process. The start-up mode may include providing a selectivation agent to the adsorbent materials. The selectivation agent may be provided in-situ, ex-situ or a combination of in-situ and ex-situ. Also, the selectivation agent may include intrinsic materials to the feed stream; extrinsic materials to the feed stream or any combination thereof. Accordingly, the present techniques may include enhancing the start-up mode.

By way of example, the swing adsorption process may include performing an adsorption step and then a regeneration step for each of the adsorbent beds, which includes performing the enhanced selectivation of the adsorbent material. The adsorption step may include passing a gaseous feed stream through the adsorbent bed to adsorb one or more contaminants from the gaseous feed stream and conducting away the resulting product stream from the adsorbent bed unit. The resulting product stream may be passed to downstream processing equipment and/or may be recycled to the adsorbent bed or another adsorbent bed unit as the gaseous feed stream. The regeneration step may include passing an external stream through the adsorbent bed to remove one or more contaminants from the adsorbent bed unit (e.g., a portion of the contaminants within the adsorbent bed unit or within the voids of the adsorbent bed) and conduct away the purge product stream from the adsorbent bed unit. The purge product stream may be set to flare or may be combined with fuel gas. During the adsorption step, the regeneration step or any combination thereof, the selectivation agent may be provided to the adsorbent bed to enhance the selectivation of the adsorbent material.

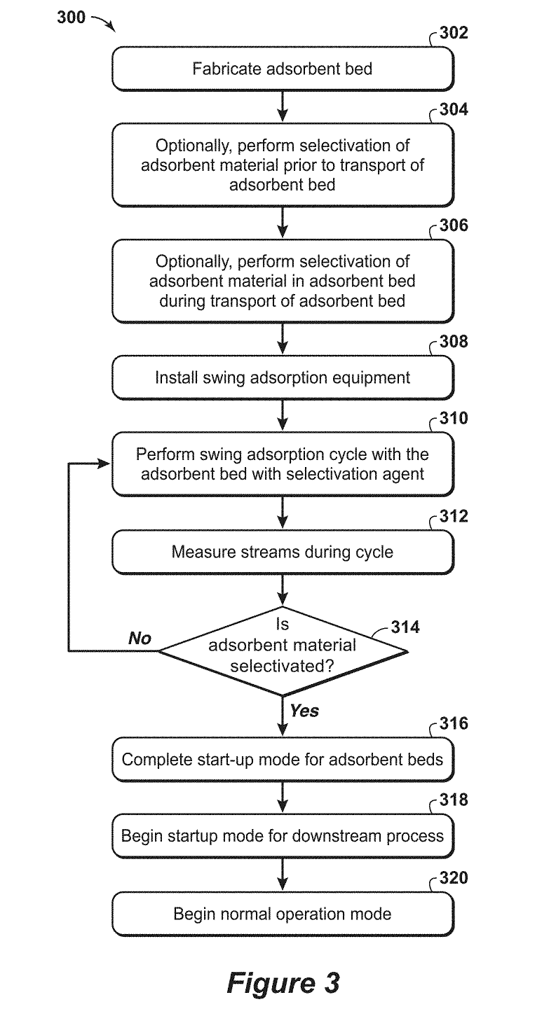

As an example, FIG. 3 is an exemplary flow chart for performing a start-up mode of a swing adsorption process in accordance with an embodiment of the present techniques. In this flow chart 300, the start-up mode process involves the use of selectivation agents to selectivate the adsorbent material from the adsorbent beds as part of the start-up mode cycle. Further, the startup operation mode process may include operating two or more adsorbent bed units, which may each be performing different steps in the start-up mode cycle. For the swing adsorption process, the adsorbent beds are fabricated and transported to the location for installation, as shown in blocks 302 to 308, the swing adsorption process then involves a start-up mode process using a selectivation agent, as shown in blocks 310 to 314, which is described as being performed for a single adsorbent bed unit for simplicity. Then, the adsorbent bed units may be used with the downstream equipment and normal operations mode are begun, as shown in blocks 316 to 320.

The process begins by the adsorbent beds are fabricated and transported to the location for installation, as shown in blocks 302 to 308. At block 302, the adsorbent bed is fabricated. The fabrication of the adsorbent bed may include disposing the adsorbent material on a structure to form the adsorbent bed or creating the adsorbent bed from the adsorbent material. At block 304, the selectivation of adsorbent material may be performed prior to transport of adsorbent bed. The selectivation of the adsorbent material may be performed in a laboratory, or in a storage location prior to transport. At block 306, the selectivation of adsorbent material may be performed in adsorbent bed during transport of adsorbent bed. The selectivation of the adsorbent material may be performed within a container during transportation. Then, the swing adsorption equipment is installed, as shown in block 308. The selectivation of the adsorbent bed may be performed after installation in the swing adsorption equipment, during start-up of the swing adsorption equipment or during normal operations of the swing equipment if the selectivity is deemed to not be adequate and needs to be adjusted. Beneficially, the selectivation may be performed in-situ, after swing adsorption equipment is installed and the swing adsorption unit is operating (e.g., during startup operations or normal operations). Accordingly, the adsorbent material may be subjected to the selectivation process to adjust the selectivity at any time following installation at the facility location.

The swing adsorption process involves a start-up mode process using a selectivation agent, as shown in blocks 310 to 314. At block 310, the swing adsorption cycle is performed with the adsorbent bed. The swing adsorption cycle may involve performing an adsorption step and a regeneration step. The regeneration step, which may be one or more purge steps, may include passing the purge stream through the adsorbent bed to create a purge product stream that is conducted away from the adsorbent bed unit. The product purge stream may include a portion of the contaminants within the adsorbent bed. This product purge stream may be intermingled with a fuel gas stream or may be flared. The adsorption step may be performed for the adsorbent bed. The adsorption step may include passing a gaseous feed stream through the adsorbent bed to remove one or more contaminants from the gaseous feed stream and to create a product stream that is conducted away from the adsorbent bed unit. The selectivation agent may be added as a selectivation spike to the adsorption step and/or regeneration step. By way of example, the selectivation agent may be added to the adsorption step, which may be added during the first half of the adsorption step, during the first third of the adsorption step, or during the first quarter of the adsorption step. Alternatively or in addition, the selectivation agent may be added to the regeneration step, which may be added during the later half of the regeneration step, during the last third of the regeneration step, or during the last quarter of the adsorption step. At block 312, streams may be measured. The product stream may be measured by a gas chromatographic unit and/or contaminant analyzer, such as a moisture analyzer or a carbon dioxide analyzer. Then, at block 314, a determination is made whether the adsorbent material is selectivated. This determination may include analyzing the product stream to determine the level of one or more of the contaminants within the product stream. If the product stream is not within specification (e.g., contaminants are at or below a specific threshold), the swing adsorption cycle with the adsorbent bed and the selectivation agent may be performed again, as shown in block 310. If the product stream is within specification (e.g., contaminants are at or below a specific threshold), the start-up mode for adsorbent beds may be completed, as shown in block 316.

The adsorbent bed units may be used with the downstream equipment and normal operations mode are begun, as shown in blocks 316 to 320. At block 316, the start-up mode for adsorbent beds may be completed. The completion of the start-up mode may include measuring the contaminants present in the product stream to verify if the product stream is within specification. At block 318, the product stream may be passed to downstream processes. Once the adsorbent bed units are passing the product stream to the downstream process, the product stream may be used with the downstream equipment. The startup operation mode for the downstream equipment may involve various steps prior to the passing of product stream to the downstream equipment or may begin once the product stream is passed to the downstream equipment. The downstream processes may include a CFZ process, a cryogenic NGL (CNGL) recovery process, or an LNG process, with the associated equipment for each. Further, during the downstream startup operation mode sequence, the adsorbent bed units may continue to utilize the external stream for the purge step. A purge stream may be passed to the adsorbent bed units from the downstream process. The purge stream may include an overhead stream or a slip stream from the downstream process. Then, the amount of a stream utilized in the purge step may be adjusted. The adjustment may be based on the amount of the purge stream being provided to the adsorbent bed units. The flow of the additional stream may be interrupted once the downstream process is producing a sufficent amount of purge stream. At block 320, the normal operation mode is begun. The normal operation mode may include passing the gaseous feed stream to the adsorbent bed units for the swing adsorption process to remove contaminants and pass the product stream to the downstream process. Then, the downstream process may pass the product stream through the various downstream equipment to produce a final product stream. The downstream process may also pass a purge stream to the swing adsorption process, which may be utilized during the regeneration step to remove contaminants from the adsorbent beds within the adsorbent bed units.

As a specific example, the feed stream may be a natural gas stream that predominately contains hydrocarbons, the contaminants within the adsorbent bed may be water. The product stream from the adsorbent bed units may be utilized in the start-up mode process for one or more downstream units, such as a demethanizer or a liquefaction train. As the downstream processes and units are being started, the spent adsorbent beds may be regenerated using a purge stream. Once the downstream processes begin normal operation mode, the purge stream may be adjusted to be provided from a residue gas stream, a fuel gas stream or other suitable stream from one of the downstream processes.

To support the external start-up mode process, a configuration of the swing adsorption process may include additional bypass conduits and manifold to pass the selectivation agent to the adsorbent bed units during the swing adsorption process cycle. The selectivation agent may be provided from an external source vessel through an external source conduit that is in fluid communication with one or more manifolds. The configuration may also include one or more separation units configured to separate the selectivation agent from one or more contaminants from the stream conducted away from the adsorbent bed unit. The separation units may be a flash separation vessel that is configured to lower the pressure of the stream to separate the selectivation agents from the remaining portion of the stream or may be an adsorption unit that interacts with the selectivation agents to separates the selectivation agents from the remaining portion of the stream. The remaining portion of the stream may be conducted away from the process, while the selectivation agents may be passed to one or more regeneration units.

As an alternative method, the startup operation mode may include a recycle startup operation mode. The recycle startup operation mode may include performing an adsorption step and then a regeneration step for each of the adsorbent beds, which involves passing the product stream between adsorbent beds. The adsorption step may include passing a gaseous feed stream through the adsorbent bed to adsorb one or more contaminants from the gaseous feed stream and conducting away the resulting product stream from the adsorbent bed unit. The resulting product stream may be passed another or second adsorbent bed that is performing the regeneration step. The product stream, which is utilized as the purge stream, may pass through the adsorbent bed to remove one or more contaminants from the adsorbent bed unit (e.g., a portion of the contaminants within the adsorbent bed unit or within the voids of the adsorbent bed) and conduct away the purge product stream from the adsorbent bed unit. The purge product stream may be set to flare or may be combined with a fuel gas stream.

By way of example, once the product stream is within specification, the product stream may be used with the downstream equipment. The startup operation mode for the downstream equipment may involve various steps prior to the passing of product stream to the downstream equipment or may begin once the product stream is passed to the downstream equipment. The downstream processes may include a CFZ process, a cryogenic NGL (CNGL) recovery process, or an LNG process, with the associated equipment for each. While the downstream process is beginning start-up mode, the adsorbent bed units may use a portion of the product stream as the purge steam for the regeneration steps of the adsorbent bed units.

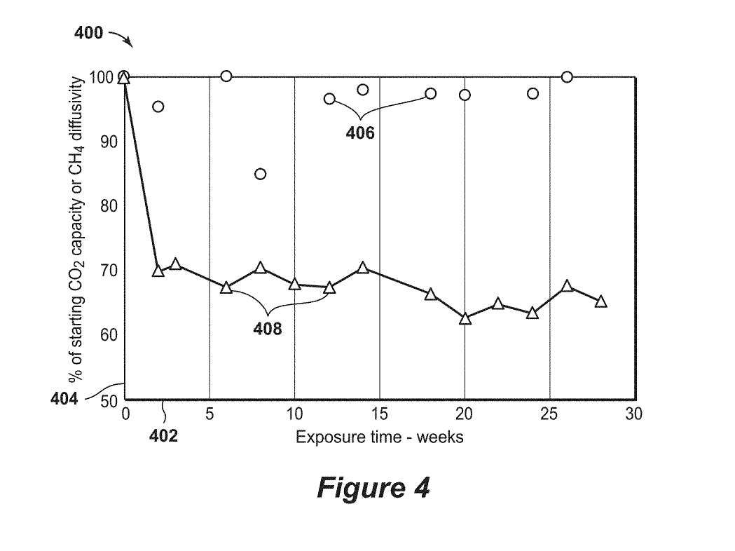

FIG. 4 is an exemplary chart 400 associated with percentage of starting CO₂ capacity or CH₄ diffusivity as compared with time. In the chart 400, the percentage of methane (CH₄) diffusivity response 406 and the CO₂ capacity response 408 in percentage of the starting CO₂ capacity is shown along an axis 404 versus a time axis 402 in exposure time in weeks. The chart 400 shows that the decrease in CH₄ adsorption does not have a negative impact on CO₂ capacity.

As may be appreciated, the removal of contaminants may result in the process operating in different modes, such as a startup operation mode and a normal operation mode. The startup operation mode may be utilized to prepare the equipment (e.g., the adsorbent bed) for the normal operation mode. The normal operation mode may be utilized when the process is receiving gaseous feed stream and removing contaminants from the gaseous feed stream to provide a product stream, which may be referred to as steady state. The process may include various combination of steps to perform the normal operations mode. The process may include removal of contaminants for dehydration or acid gas.

By way of example, the provided processes, apparatus, and systems of the present techniques may be used in swing adsorption processes that remove contaminants (CO₂, H₂O, and H₂S) from feed streams, such as hydrocarbon containing streams. As may be appreciated and as noted above, the hydrocarbon containing feed streams may have different compositions. For example, hydrocarbon feed streams vary widely in amount of acid gas, such as from several parts per million acid gas to 90 volume percent (vol. %) acid gas. Non-limiting examples of acid gas concentrations from exemplary gas reserves sources include concentrations of approximately: (a) 4 ppm H₂S, 2 vol. % CO₂, 100 ppm H₂O (b) 4 ppm H₂S, 0.5 vol. % CO₂, 200 ppm H₂O (c) 1 vol. % H₂S, 2 vol. % CO₂, 150 ppm H₂O, (d) 4 ppm H₂S, 2 vol. % CO₂, 500 ppm H₂O, and (e) 1 vol. % H₂S, 5 vol. % CO₂, 500 ppm H₂O. Further, in certain applications the hydrocarbon containing stream may include predominately hydrocarbons with specific amounts of CO₂ and/or water. For example, the hydrocarbon containing stream may have greater than 0.00005 volume percent CO₂ based on the total volume of the gaseous feed stream and less than 2 volume percent CO₂ based on the total volume of the gaseous feed stream; or less than 10 volume percent CO₂ based on the total volume of the gaseous feed stream. The processing of feed streams may be more problematic when certain specifications have to be satisfied.

The removal of contaminants may be performed by swing adsorption processes during normal operations to prepare the stream for further downstream processing, such as CNGL processing and/or LNG processing. For example, natural gas feed streams for liquefied natural gas (LNG) applications have stringent specifications on the CO₂ content to ensure against formation of solid CO₂ at cryogenic temperatures. The LNG specifications may involve the CO₂ content to be less than or equal to 50 ppm. Such specifications are not applied on natural gas streams in pipeline networks, which may involve the CO₂ content up to 2 vol. % based on the total volume of the gaseous feed stream. As such, for LNG facilities that use the pipeline gas (e.g., natural gas) as the raw feed, additional treating or processing steps are utilized to further purify the stream. Further, the present techniques may be used to lower the water content of the stream to less than 0.1 ppm. Exemplary swing adsorption processes and configurations may include U.S. Pat. Nos. 8,545,602; 9,168,485; 9,168,483 and 9,095,809 along with U.S. Patent Ser. Nos. 62/213,262; 62/213,267; 62/213,270; 62/213,273; 62/246,916; 62/246,920; and 62/246,922, which are each incorporated by reference herein.

The present techniques provide configurations and processes that are utilized to enhance the start-up mode for the swing adsorption process and associated downstream processes. While the normal operation mode processes are described based as steady state operation, startup operation mode procedures involve different cycles until normal operation mode is begun. The present techniques describes different methods that may be utilized to transition the operation from start-up mode to normal operation mode. In start-up mode, each of the adsorbent beds utilized in the swing adsorption process is assumed to be in equilibrium with contaminants. For dehydration applications, the contaminant is water (H₂O), while for carbon dioxide (CO₂) applications, the contaminant is either H₂O (e.g., in equilibrium with atmosphere) or CO₂ (e.g., in case of a shutdown). Accordingly, the start-up mode is utilized to remove contaminants to prepare the adsorbent beds for normal operation mode. In particular, the start-up mode sequence may be used for swing adsorption processes (e.g., dehydration and low-level CO₂ removal) upstream or integrated with CNGL and LNG applications.

To facilitate rapid regeneration, the operating conditions may be adjusted to manage the removal of contaminants from the adsorbent bed and selectivation of the adsorbent material. For example, the flow rate for the gaseous feed stream may be conducted within a flow rate range below the normal operation mode flow ranges (e.g., flow rate at turndown). For example, the flow rates in startup operation mode may be at about 25% of the normal operation mode flow rate, at about 50% of the normal operation mode flow rate, at about 75% of the normal operation mode flow rate, in a range between 25% and 90% of the normal operation flow rate, in a range between 50% and 90% of the normal operation flow rate, and in a range between 75% and 90% of the normal operation flow rate. Further, the regeneration of the adsorbent bed may be conducted within a pressure range near atmospheric pressure (e.g., in a pressure range between atmospheric pressure and fifty pounds per square inch gauge (psi) above atmospheric pressure) or may be within a pressure range near normal operation mode pressures (e.g., in a pressure range between 75% of normal operation mode pressure and normal operation mode pressure). As an example, the regeneration of the adsorbent bed may be conducted in a pressure range from 100 pounds per square inch gauge (psi) to 450 psi. Also, the temperature of the external medium stream may be provided within a temperature range from (e.g., in a temperature range between 20° Celsius (C) above atmospheric temperature and 150° Celsius (C) above atmospheric temperature).

For a dehydration application, the sequence of the cycle for the startup operation mode may be configured to lessen flaring of gas or completely eliminate flaring of gas. The recycle sequence may be initiated at turndown. The purge pressure is selected such that the purge product is at the suction pressure of the residue gas compressor. The residue gas compressor is then operated to compress the purge product and recombine with the feed stream either upstream or downstream of a triethylene glycol (TEG) unit. Knockout drums may be necessary to remove the excess water gathered from the purge step.

The present techniques provide a start-up mode process that may be utilized to initiate the normal operation mode process for a swing adsorption process, and specifically a rapid cycle adsorption process. The present techniques may include some additional equipment, such as one or more conduits and/or one or more manifolds that provide a fluid path for the external gas stream, an external gas storage tank, a heating unit (e.g., furnace and/or heat exchanger), one or more blowers and/or one or more compressors to fluidly communication with one or more adsorbent beds, and/or depressurizing equipment that may be utilized to facilitate the startup operation mode cycle. In addition, other components and configurations may be utilized to provide the swing adsorption process, such as rapid cycle enabling hardware components (e.g., parallel channel adsorbent bed designs, rapid actuating valves, adsorbent bed configurations that integrate with other processes). Exemplary swing adsorption processes and configurations may also include U.S. Patent Ser. Nos. 62/213,262; 62/213,267; 62/213,270; 62/213,273; 62/246,916; 62/246,920; and 62/246,922, which are each incorporated by reference herein.

In other certain embodiments, the startup operation mode for the swing adsorption process may be integrated with downstream equipment and processes. The downstream equipment and processes may include control freeze zone (CFZ) applications, niotrogen removal unit (NRU), cryogenic NGL recovery applications, LNG applications, and other such applications. Each of these different applications may include different specifications for the feed stream in the respective process. For example, the startup operations may involve dehydration upstream of a cryogenic NGL process or an LNG process and may be integrated with the respective downstream equipment. As another example, the startup operations may involve CO₂ removal upstream of a cryogenic NGL process or the LNG process and may be integrated with respective downstream equipment. Other embodiments may involve a combination of the two startup operation mode processes. The startup method may include using an external medium as part of the process, which may be a dry nitrogen stream. Also, the startup method may involve progressively dehydrating and/or cleaning the adsorbent beds by passing the product stream through one or more adsorbent beds. Further, the startup operation mode may be integrated with downstream processes, such as cryogenic NGL processes and/or LNG processes. In addition, the startup operation mode process may involve performing the startup operation mode cycle with minimal flaring or no flaring.

In certain embodiments, the system utilizes a combined swing adsorption process, which combines TSA and PSA, for treating of pipeline quality natural gas to remove contaminants for the stream to satisfy LNG specifications. The swing adsorption process, which may be a rapid cycle process, is used to treat natural gas that is at pipeline specifications (e.g., a feed stream of predominately hydrocarbons along with less than or equal to about 2% volume CO₂ and/or less than or equal to 4 ppm H₂S) to form a stream satisfying the LNG specifications (e.g., less than 50 ppm CO₂ and less than about 4 ppm H₂S). The product stream, which may be the LNG feed stream, may have greater than 98 volume percent hydrocarbons based on the total volume of the product stream, while the CO₂ and water content are below certain thresholds. The LNG specifications and cryogenic NGL specifications may involve the CO₂ content to be less than or equal to 50 ppm, while the water content of the stream may be less than 0.1 ppm.

In certain aspects, as described further below, the present techniques may involve using a high temperature purge stream that is provided to the adsorbent beds as part of the purge step to heat the adsorbent bed. The purge stream may be heated to temperature may be less than 500° F., less than 450° F. or may be less than 400° F., and may be greater than 100° F. of the purge stream temperature, greater than 150° F. of the purge stream temperature or greater than 200° F. of the purge stream temperature. The purge stream pressure may be in the range between 0.01 bara and 100 bara, between 1 bara and 80 bara, or between 2 bara and 50 bara.

Further, the present techniques may not remove all of the contaminant (e.g., H₂O and CO₂) adsorbed in the bed during the purge step of the startup operation mode process, but remove a portion of the contaminants such that the product end of the adsorption bed has a contaminant loading sufficiently low to provide a product stream with less than specifications. Accordingly, the product end of the adsorbent bed may be maintained nearly free of contaminants (e.g., the CO₂ loading for the region near the product end is less than 1 millimole per gram (mmol/g), less than 0.5 mmol/g or less than 0.1 mmol/g).

Further, in other embodiments, the pressure of the different streams may be varied. For example, the feed stream may involve a feed pressure that ranges range between 50 bar absolute (bara) and 150 bara, between 40 bara and 150 bara, or preferably between 50 bara and 100 bara, but is not necessarily limited to this range. The feed temperature may be in the range between 0° F. and 200° F., in the range between 20° F. and 175° F. or in the range between 40° F. and 150° F. The blowdown pressure, heating pressure, and purge pressure may be adjusted depending on the cycle, may depend upon the adsorbent material being utilized and/or may range from vacuum to feed pressure. For example, if the adsorbent material is zeolite 4A, the blowdown pressure range may be between 0.01 bara to 15 bara, or more preferably in a range between 1 bara and 9 bara. This example may depend on the feed concentration of CO₂. Also, in other embodiments, the depressurization steps may be adjusted such that the pressure swing is achieved in stages to vary the amount of methane desorbing during each step, if any. Additionally, a heating loop may be introduced and the heating pressure in the heating loop may be operated at a pressure different from the purge pressure or blowdown pressure in the respective steps. Also, certain embodiments may include no pressure swing, but may rely upon temperature swing for the regeneration step. Similarly, in the other embodiments, no temperature swing may be performed and the regeneration step may be performed by pressure swing.

In certain configurations, an integrated rapid cycle adsorption system may be utilized to remove multiple contaminants (e.g., water and CO₂). Suitable adsorbent material or adsorbent layers may be utilized to provide the dehydration, which may be the same or different from the adsorbent material used to in the removal of other contaminants, such as CO₂.

Moreover, the present techniques may include a specific process flow during normal operation mode to remove contaminants, such as CO₂ and/or water. For example, the process may include an adsorbent step and a regeneration step, which form the cycle. The adsorbent step may include passing a gaseous feed stream at a feed pressure and feed temperature through an adsorbent bed unit to separate one or more contaminants from the gaseous feed stream to form a product stream. The feed stream may be passed through the adsorbent bed in a forward direction (e.g., from the feed end of the adsorbent bed to the product end of the adsorbent bed). Then, the flow of the gaseous feed stream may be interrupted for a regeneration step. The regeneration step may include one or more depressurization steps, one or more heating steps, and/or one or more purge steps. The depressurization steps, which may be or include a blowdown step, may include reducing the pressure of the adsorbent bed unit by a predetermined amount for each successive depressurization step, which may be a single step and/or multiple steps. The depressurization step may be provided in a forward direction or may preferably be provided in a countercurrent direction (e.g., from the product end of the adsorbent bed to the feed end of the adsorbent bed). The heating step may include passing a heating stream into the adsorbent bed unit, which may be a recycled stream through the heating loop and is used to heat the adsorbent material. The purge step may include passing a purge stream into the adsorbent bed unit, which may be a once through purge step and the purge stream may be provided in countercurrent flow relative to the feed stream. The purge stream may be provided at a purge temperature and purge pressure, which may include the purge temperature and purge pressure being similar to the heating temperature and heating pressure used in the heating step. Then, the cycle may be repeated for additional streams. Additionally, the process may include one or more re-pressurization steps after the purge step and prior to the adsorption step. The one or more re-pressurization steps may be performed, wherein the pressure within the adsorbent bed unit is increased with each re-pressurization step by a predetermined amount with each successive re-pressurization step. The cycle duration may be for a period greater than 1 second and less than 600 seconds, for a period greater than 2 second and less than 180 seconds or for a period greater than 5 second and less than 90 seconds.

In one or more embodiments, the present techniques can be used for any type of swing adsorption process. Non-limiting swing adsorption processes for which the present techniques may be used include pressure swing adsorption (PSA), vacuum pressure swing adsorption (VPSA), temperature swing adsorption (TSA), partial pressure swing adsorption (PPSA), rapid cycle pressure swing adsorption (RCPSA), rapid cycle thermal swing adsorption (RCTSA), rapid cycle partial pressure swing adsorption (RCPPSA), as well as combinations of these processes. For example, the preferred swing adsorption process may include a combined pressure swing adsorption and temperature swing adsorption, which may be performed as a rapid cycle process. Exemplary swing adsorption processes are further described in U.S. Patent Ser. Nos. 62/213,262; 62/213,267; 62/213,270; 62/213,273; 62/246,916; 62/246,920; and 62/246,922 and U.S. Patent Application Publication Nos. 2008/0282892, 2008/0282887, 2008/0282886, 2008/0282885, 2008/0282884 and 2014/0013955, which are each herein incorporated by reference in their entirety.

Further still, in one or more embodiments, a variety of adsorbent materials may be used to provide the mechanism for the separations. Examples include zeolite 3A, 4A, 5A, ZK4 and MOF-74. However, the process is not limited to these adsorbent materials, and others may be used as well.

In one or more embodiments, the material may include an adsorbent material supported on a non-adsorbent support. The adsorbent materials may include alumina, microporous zeolites, carbons, cationic zeolites, high silica zeolites, highly siliceous ordered mesoporous materials, sol gel materials, aluminum phosphorous and oxygen (ALPO) materials (microporous and mesoporous materials containing predominantly aluminum phosphorous and oxygen), silicon aluminum phosphorous and oxygen (SAPO) materials (microporous and mesoporous materials containing predominantly silicon aluminum phosphorous and oxygen), metal organic framework (MOF) materials (microporous and mesoporous materials comprised of a metal organic framework) and zeolitic imidazolate frameworks (ZIF) materials (microporous and mesoporous materials comprised of zeolitic imidazolate frameworks). Other materials include microporous and mesoporous sorbents functionalized with functional groups. Examples of functional groups include primary, secondary, tertiary amines and other non protogenic basic groups such as amidines, guanidines and biguanides.

In one or more embodiments, the adsorption bed unit may be utilized to separate contaminants from a feed stream. The method may include passing a gaseous feed stream at a feed pressure through an adsorbent bed unit having an adsorbent contactor to separate one or more contaminants from the gaseous feed stream to form a product stream, wherein the adsorbent contactor has a first portion and a second portion; interrupting the flow of the gaseous feed stream; performing a depressurization step, wherein the depressurization step reduces the pressure within the adsorbent bed unit; performing an optional heating step, wherein the heating step increases the temperature of the adsorbent bed unit to form a temperature differential between the feed end of the adsorbent bed and the product end of the adsorbent bed; and performing a purge step, wherein the purge step reduces the pressure within the adsorbent bed unit; performing a re-pressurization step, wherein the re-pressurization step increases the pressure within the adsorbent bed unit; and repeating the steps a) to e) for at least one additional cycle.

In one or more embodiments, when using RCTSA the total cycle times are typically less than 600 seconds, preferably less than 180 seconds, more preferably less than 90 seconds, and even more preferably less than 60 seconds. Also, the RCPSA the total cycle times are typically less than 300 seconds, preferably less than 180 seconds, more preferably less than 90 seconds, and even more preferably less than 60 seconds.

In view of the many possible embodiments to which the principles of the disclosed invention may be applied, it should be recognized that the illustrative embodiments are only preferred examples of the invention and should not be taken as limiting the scope of the invention.

What is claimed is:

1. A method for performing a swing adsorption process, the method comprising:
a) performing a swing adsorption cycle, wherein the swing adsorption cycle comprises performing an adsorption step that comprises passing a feed stream through an adsorbent bed unit having an adsorbent material to separate one or more contaminants from the feed stream to form a product stream, wherein a selectivation agent is passed through the adsorbent material during the swing adsorption cycle;
b) determining whether the adsorbent material is selectivated;
c) if the adsorbent material is not selectivated, repeating steps a) to b) for at least one additional swing adsorption cycle; and
d) if the adsorbent material is selectivated; performing normal operations with the adsorption material.

2. The method of claim 1, wherein performing the adsorption step comprises mixing the selectivation agent with the feed stream and passing the selectivation agent and the feed stream through the adsorbent bed unit.

3. The method of claim 2, wherein the selectivation agent is mixed with the feed stream during a first half of the adsorption step or during a first quarter of the adsorption step.

4. The method of claim 1, wherein performing the swing adsorption cycle comprises performing a purge step that involves passing a purge stream through an adsorbent bed unit to remove one or more contaminants from an adsorbent bed within a housing of the adsorbent bed unit to form a purge product stream.

5. The method of claim 4, wherein performing the purge step comprises mixing the selectivation agent with the purge stream and passing the selectivation agent and the purge stream through the adsorbent bed unit.

6. The method of claim 5, wherein the selectivation agent is mixed with the purge stream during a last half of the purge step or during a last quarter of the purge step.

7. The method of claim 5, wherein performing the swing adsorption cycle comprises:
determining whether the product stream is within a specification for a contaminant;
if the product stream is within the specification, passing the product stream to a downstream process; and
if the product stream is not within the specification, repeating the swing adsorption cycle for at least one additional cycle.

8. The method of claim 1, wherein the selectivation agent includes compounds that are intrinsic to the feed stream.

9. The method of claim 1, wherein the selectivation agent includes compounds that are extrinsic to the feed stream.

10. The method of claim 1, wherein the selectivation agent comprises water.

11. The method of claim 1, wherein the duration of the swing adsorption cycle is for a period greater than 1 second and less than 600 seconds.

12. The method of claim 1, wherein the feed stream is a hydrocarbon containing stream having greater than one volume percent hydrocarbons based on the total volume of the feed stream.

13. The method of claim 12, wherein the feed stream comprises hydrocarbons and CO₂, wherein the CO₂ content is in the range of two hundred parts per million volume and less than or equal to about 2% volume of the feed stream.

14. The method of claim 13, wherein the adsorbent bed unit is configured to lower the carbon dioxide (CO₂) level in the product stream to less than 50 parts per million.

15. The method of claim 1, further comprising:
passing the product stream from the adsorbent bed unit to a liquefied natural gas (LNG) process unit; and
separating a flash fuel stream from the LNG process unit to be utilized as at least a portion of the purge stream.

16. The method of claim 1, further comprising:
passing the product stream from the adsorbent bed unit to a cryogenic natural gas liquefaction (CNGL) process unit; and
separating an overhead stream from the CNGL process unit to be utilized as at least a portion of the purge stream.

17. The method of claim 1, further comprising contacting the adsorbent material with the selectivation agent prior to disposing the adsorbent material into the adsorbent bed unit.

18. A cyclical swing adsorption system comprising:
a plurality of manifolds, wherein the plurality of manifolds comprise a feed manifold configured to pass a feed stream to the plurality of adsorbent bed units during an adsorption step, a product manifold configured to pass a product stream from the plurality of adsorbent bed units during the adsorption step, a purge manifold configured to pass a purge stream to the plurality of adsorbent bed units during a regeneration step, a purge product manifold configured to pass a purge product stream from the plurality of adsorbent bed units during the regeneration step, and a selectivation manifold configured to pass a selectivation agent to the plurality of adsorbent bed units;
a plurality of adsorbent bed units coupled to the plurality of manifolds, each of the adsorbent bed units comprising:
a housing;
an adsorbent material disposed within the housing; and
a plurality of valves, wherein at least one of the plurality of valves is associated with one of the plurality of manifolds and is configured to manage fluid flow along a flow path extending between the respective manifold and the adsorbent material.

19. The cyclical swing adsorption system of claim 18, wherein the plurality of valves comprise one or more poppet valves.

20. The cyclical swing adsorption system of claim 18, wherein the plurality of manifolds and the plurality of adsorbent bed units are configured to operate at pressures between 0.1 bar absolute (bara) and 100 bara.

21. The cyclical swing adsorption system of claim 18, further comprising a selectivation agent valve in fluid communication with the feed manifold and configured to provide a flow passage for the selectivation agent from an external storage vessel to the feed manifold in a start-up mode position and configured to block the flow passage of the selectivation agent from the external storage vessel to the feed manifold in a normal operation mode position.

22. The cyclical swing adsorption system of claim 21, further comprising a conditioning unit disposed downstream of the product manifold and upstream of the external storage vessel, wherein the conditioning unit is configured to remove selectivation agents from the product stream.

23. The cyclical swing adsorption system of claim 18, further comprising a selectivation agent valve in fluid communication with the purge manifold and configured to provide a flow passage for the selectivation agent from an external storage vessel to the purge manifold in a start-up mode position and configured to block the flow passage of the selectivation agent from the external storage vessel to the purge manifold in a normal operation mode position.

24. The cyclical swing adsorption system of claim 23, further comprising a conditioning unit disposed downstream of the purge product manifold and upstream of the external storage vessel, wherein the conditioning unit is configured to remove selectivation agents from the purge product stream.

25. The cyclical swing adsorption system of claim 24, further comprising a liquefied natural gas (LNG) process unit in fluid communication with the adsorbent bed unit and configured to receive the product stream and separate the product stream into a final product stream and a flash fuel stream, wherein the flash fuel stream is passed to the purge manifold.
